(19) United States
(12) Patent Application Publication
(10) Pub. No.: US 2016/0241703 A1
(43) Pub. Date: Aug. 18, 2016

(54) INFORMATION PROCESSING SYSTEM AND DEVICE CONTROL METHOD

(71) Applicant: Yutaka YAGIURA, Kanagawa (JP)

(72) Inventor: Yutaka YAGIURA, Kanagawa (JP)

(73) Assignee: RICOH COMPANY, LTD., Tokyo (JP)

(21) Appl. No.: 14/991,008

(22) Filed: Jan. 8, 2016

(30) Foreign Application Priority Data
Feb. 16, 2015 (JP) 2015-027290

(51) Int. Cl. H04M 1/725; H04W 76/06; H04W 12/06

(52) U.S. Cl. CPC H04M 1/72533; H04W 12/06; H04W 76/068

(57) ABSTRACT

An information processing system includes a terminal apparatus and an electronic device that establish communication using a first communication interface and a second communication interface that has a shorter communication range than the first communication interface. The electronic device includes a certification information transmitting unit that transmits certification information using the second communication interface, a verifying unit that verifies whether the certification information is attached to a request accepted from the terminal apparatus using the first or second communication interface, and an execution unit that executes a process according to the accepted request if the certification information is attached thereto. The terminal apparatus includes a certification information receiving unit that receives the certification information from the electronic device using the second communication interface, and a request unit that transmits the request to the electronic device along with the certification information using the first or second communication interface.

### BACKGROUND OF THE INVENTION

1. Field of the Invention

The present invention relates to an information processing system and a device control method.

2. Description of the Related Art

Electronic devices are known that have a service interface installed therein for enabling a smart device to remotely access and use a network interface, for example.

For example, Japanese Laid-Open Patent Publication No. 2011-41132 discloses a digital multifunction peripheral (MFP) that executes power mode switching/control based on a calculation result of a distance between the digital MFP and an identification information transmitting device that is carried by a user. Upon detecting that the identification information transmitting device has come close to the digital MFP or has entered a predetermined distance range from the digital MFP, the digital MFP is configured to switch the power mode to standby mode from power-saving mode, or automatically switch to a mode enabling print operations, for example.

Electronic devices such as printers, MFPs, and projectors may be connected to a network such as a LAN to be controlled by various terminal apparatuses such as a mobile phone, a smartphone, or a tablet terminal that is operated by a user, for example.

However, in a case where a plurality of electronic devices are connected to a network such as a LAN and a user wishes to use one electronic device of the plurality of electronic devices, the user may end up erroneously controlling an electronic device that the user has not intended to use.

### SUMMARY OF THE INVENTION

An aspect of the present invention is directed to providing an information processing system and a device control method for preventing a user from erroneously controlling an electronic device that the user has not intended to use.

According to one embodiment of the present invention, an information processing system is provided that includes at least one terminal apparatus that is operated by a user, and at least one electronic device that is controlled from the terminal apparatus, wherein the terminal apparatus and the electronic device are configured to establish communication using a first communication interface having a first communication range and a second communication interface having a second communication range that is shorter than the first communication range. The electronic device includes a certification information transmitting unit configured to transmit certification information using the second communication interface, a verifying unit configured to verify whether the certification information is attached to a request from the terminal apparatus that is accepted using the first communication interface or the second communication interface, and an execution unit configured to execute a process according to the request accepted from the terminal apparatus if the certification information is attached to the request. The terminal apparatus includes a certification information receiving unit configured to receive the certification information that has been transmitted by the electronic device using the second communication interface, and a request unit configured to attach the certification information to the request and transmit the request along with the certification information to the electronic device using the first communication interface or the second communication interface.

### BRIEF DESCRIPTION OF THE DRAWINGS

FIG. 1 is a block diagram illustrating an exemplary configuration of an information processing system according to an embodiment of the present invention;

FIG. 2 is block diagram illustrating an exemplary hardware configuration of a computer according to an embodiment of the present invention;

FIG. 3 is block diagram illustrating an exemplary hardware configuration of a terminal apparatus according to an embodiment of the present invention;

FIG. 4 is block diagram illustrating an exemplary hardware configuration of an MFP according to an embodiment of the present invention;

FIG. 5 is block diagram illustrating an exemplary functional configuration of a smart device according to an embodiment of the present invention;

FIG. 6 is a table illustrating an exemplary configuration of information stored in a PIN code information storage unit;

FIG. 7 is a block diagram illustrating an exemplary functional configuration of the MFP according to an embodiment of the present invention;

FIG. 8 is a table illustrating an exemplary configuration of information stored in an output job information storage unit;

FIG. 9 is a sequence chart illustrating exemplary process steps of a print process according to an embodiment of the present invention;

FIG. 10 illustrates an example of a selection screen for selecting an electronic device as a print job submission destination;

FIG. 11 is a table illustrating an exemplary configuration of security code information stored in a security code storage unit;

FIG. 12 is a sequence chart illustrating exemplary process steps of a print process according to another embodiment of the present invention;

FIG. 13 illustrates an example of a setting screen for prompting a user to enter a PIN code and a user ID;

FIG. 14 is a sequence chart illustrating exemplary process steps of a display process implemented by an interactive whiteboard according to an embodiment of the present invention;

FIG. 15 is a block diagram illustrating another exemplary configuration of an information processing system according to an embodiment of the present invention;

FIG. 16 is a block diagram illustrating an exemplary functional configuration of a security beacon according to an embodiment of the present invention;

FIG. 17 is a sequence chart illustrating exemplary process steps of a print process according to another embodiment of the present invention; and

FIG. 18 illustrates an example of an electronic device that receives transmissions from multiple security beacons.

### DESCRIPTION OF THE PREFERRED EMBODIMENTS

In the following, embodiments of the present invention are described with reference to the accompanying drawings.

### System Configuration

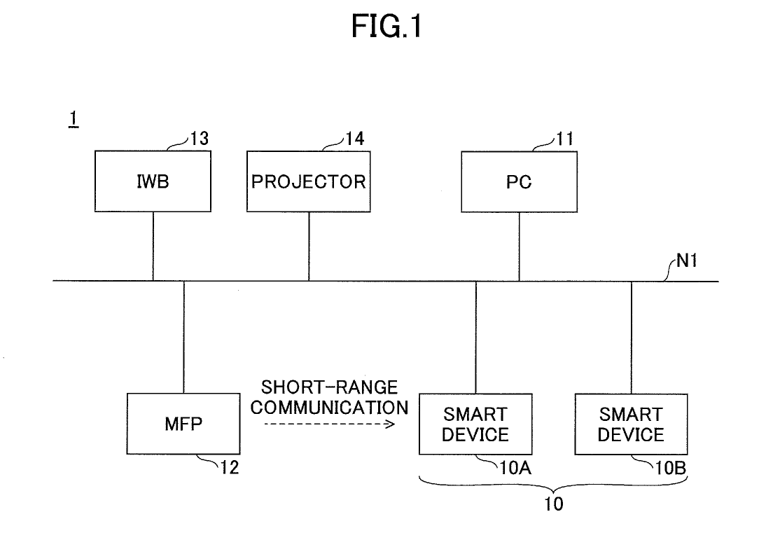

FIG. 1 is a block diagram illustrating an exemplary configuration of an information processing system 1 according to an embodiment of the present invention. The information processing system 1 of FIG. 1 includes smart devices 10A and 10B, a personal computer (PC) 11, a multifunction peripheral (MFP) 12, an interactive whiteboard (IWB) 13, and a projector 14.

In the information processing system 1, the smart devices 10A and 10B, the PC 11, the MFP 12, the IWB 13, and the projector 14 are connected to a network N1 such as a LAN. Note that in the following descriptions, the smart devices 10A and 10B may simply be referred to as “smart device 10” when their distinction is not particularly relevant.

The smart device 10 is an example of a terminal apparatus that is operated by a user. The terminal apparatus may be any device that can be operated by a user including a smartphone, a mobile phone, a notebook PC, and a tablet terminal, for example. The PC 11 is also an example of terminal apparatus that is operated by a user.

The MFP 12, the IWB 13, and the projector 14 are examples of an electronic device that can be controlled from the smart device 10, for example. The electronic device provides services such as printing, screen rendering, capturing, and the like to a user via the network N1. The electronic device provides an interface to the network N1.

Also, the electronic device provides an interface used for short-range communication such as BLE (Bluetooth Low Energy). Note that the interface for short-range communication provided by the electronic device does not necessarily have to be capable of establishing bidirectional communication as long as it is capable of establishing one-way communication from the electronic device to the smart device 10. Note that the communication range of the short-range communication provided by the electronic device may be a distance of about several meters to several tens of meters from the electronic device, for example.

Note that short-range wireless communication such as Bluetooth (registered trademark) or NFC (Near Field Communication) may be used as the short-range communication provided by the electronic device. The electronic device uses short-range communication to transmit information to the smart device 10 as described below.

The MFP 12 is an example of an image forming apparatus. The MFP 12 includes an image capturing function, an image forming function, and a communication function, and may be used as a printer, a facsimile, a scanner, and a copying machine, for example. The IWB 13 is an example of an image display apparatus. The IWB 13 includes a display function and a communication function. The projector 14 is an example of an image projection apparatus. The projector 14 includes a projection function and a communication function.

### Hardware Configuration

<<Computer>>

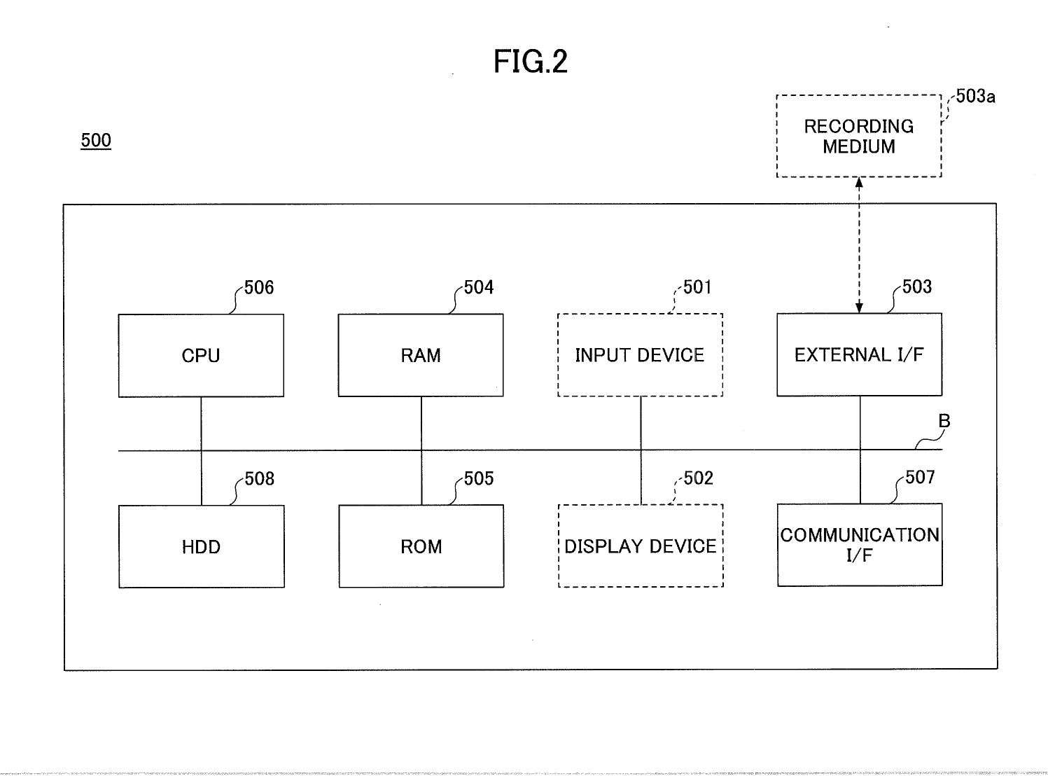

The PC 11 may be implemented by a computer 500 having a hardware configuration as illustrated in FIG. 2, for example. FIG. 2 is a block diagram illustrating an exemplary hardware configuration of the computer 500 according an embodiment of the present invention.

In FIG. 2, the computer 500 includes an input device 501, a display device 502, an external I/F 503, a RAM 504, a ROM 505, a CPU 506, a communication I/F 507, and a hard disk drive (HDD) 508 that are interconnected via a bus B. Note that in some embodiments, the input device 501 and the display device 502 may be connected to the computer 500 when they need to be used, for example.

The input device 501 may include a keyboard, a mouse, and/or a touch panel, for example, and is operated by a user to input various operation signals to the computer 500. The display device 502 may include a display, for example, and is configured to display processing results of the computer 500.

The communication I/F 507 is an interface for connecting the computer 500 to various networks. The computer 500 may establish data communication with other computers via the communication I/F 507.

The HDD 508 is a nonvolatile storage device storing programs and data. The programs stored in the HDD 508 may include an operating system (OS) corresponding to basic software controlling overall operations of the computer 500, and application software (also simply referred to as “application” hereinafter) providing various functions under the control of the OS, for example. Note that in some embodiments, the computer 500 may include a drive apparatus such as a solid state drive (SSD) that uses a flash memory as a recording medium instead of the HDD 508.

The external I/F 503 is an interface between the computer 500 and an external device. The external device may be a recording medium 503a, for example. The computer 500 may read information from and/or write information on the recording medium 503a via the external I/F 503. Specific examples of the recording medium 503a include a flexible disk, a compact disk (CD), a digital versatile disk (DVD), a SD memory card, a universal serial bus (USB) memory, and the like.

The ROM 505 is a nonvolatile semiconductor memory (storage device) that can store programs and/or data even when the power is turned off. The ROM 505 may store programs and data such as a basic input/output system (BIOS) to be performed when the computer 500 is started, OS settings, network settings, and the like. The RAM 504 is a volatile semiconductor memory (storage device) that temporarily stores programs and/or data.

The CPU 506 includes a computing unit that reads a program and/or data from a storage device such as the ROM 505 and/or the HDD 508, loads the program and/or data in the RAM 504, and executes processes according to the program and/or data to control the overall operations and functions of the computer 500.

The PC 11 may implement various processes as described below using the hardware configuration of the computer 500 as illustrated in FIG. 2, for example.

<<Terminal Apparatus>>

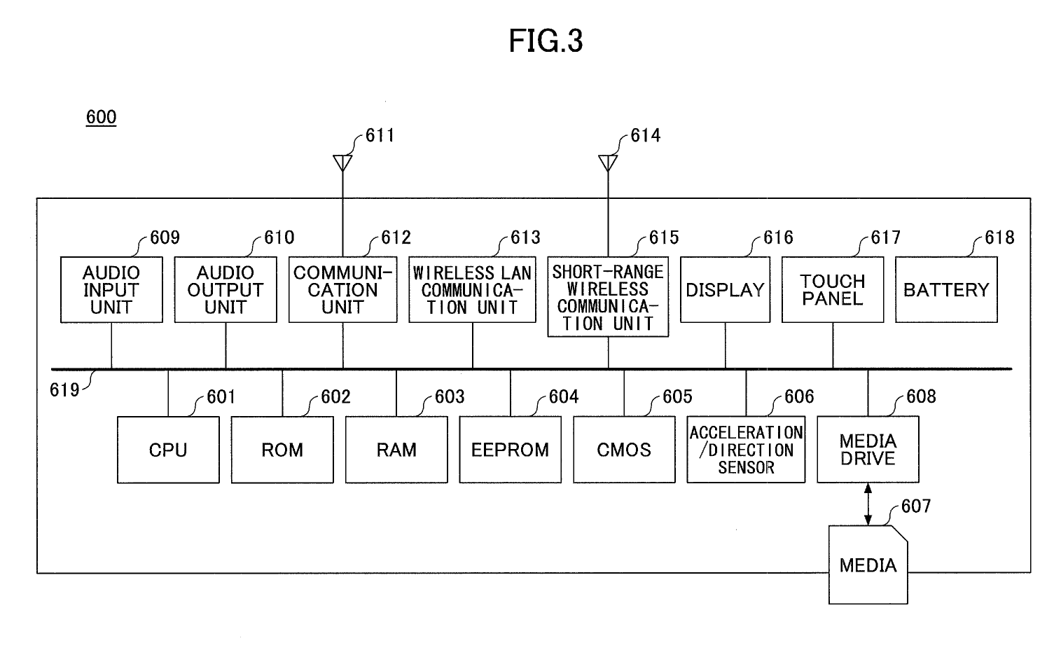

The smart device 10 may be implemented by a terminal apparatus 600 having a hardware configuration as illustrated in FIG. 3, for example. FIG. 3 is a block diagram illustrating an exemplary hardware configuration of the terminal apparatus 600 according to an embodiment of the present invention.

In FIG. 3, the terminal apparatus 600 includes a CPU 601, a ROM 602, a RAM 603, an EEPROM (Electrically Erasable Read Only Memory) 604, a CMOS (Complementary Metal-Oxide Semiconductor) sensor 605, an acceleration/direction sensor 606, and a media drive 608.

The CPU 601 controls overall operations of the terminal apparatus 600. The ROM 602 stores basic input/output programs. The RAM 603 is used as a work area of the CPU 601. The EEPROM 604 reads and writes data according to control of the CPU 601. The CMOS sensor 605 captures an image of an object and obtains image data of the object according to control by the CPU 601. The acceleration/direction sensor 606 may include an electromagnetic compass or a gyrocompass that detects terrestrial magnetism, and an acceleration sensor, for example.

The media drive 608 controls reading/writing (storing) of data with respect to recording media 607 such as a flash memory. The recording media 607 may be detachably loaded into the media drive 608 so that data recorded in the recording media 607 can be read from the recording media 607 and/or new data can be written (stored) in the recording media 607.

The EEPROM 604 may store an OS to be performed by the CPU 601 and required association information for setting up a network, for example. Note that applications for executing various processes according to the present embodiment may be stored in the EEPROM 604 or the recording medi0 607, for example.

The CMOS sensor 605 is an image sensor that converts light into an electrical charge to digitize an image of an object. The CMOS sensor 605 is not limited to a CMOS sensor but may be other types of image sensors such as a CCD (Charge Coupled Device) sensor as long as the sensor can capture an image of an object.

In FIG. 3, the terminal apparatus 600 further includes an audio input unit 609, an audio output unit 610, an antenna 611, a communication unit 612, a wireless LAN communication unit 613, a short-range wireless communication antenna 614, a short-range wireless communication unit 615, a display 616, a touch panel 617, and a bus line 619.

The audio input unit 609 converts audio into audio signals. The audio output unit 610 converts audio signals into audio. The communication unit 612 transmits/receives wireless signals to/from a nearest base station using the antenna 611. The wireless LAN communication unit 613 establishes wireless communication with an access point according to the IEEE80411 standard. The short-range wireless communication unit 615 establishes short-range wireless communication using the short-range wireless communication antenna 614.

The display 616 may be a liquid crystal display or an organic electro-luminescence display that displays an image of an object and various icons, for example. The touch panel 617 may be, for example, a pressure sensitive panel or an electrostatic panel arranged on the display 616 that detects a touch position on the display 616 touched by a finger, a pen, or the like, for example. The bus line 619 may be, for example, an address bus or a data bus for electrically connecting the aforementioned parts and components of the terminal apparatus 600.

The terminal apparatus 600 also includes a dedicated battery 618. The terminal apparatus 600 is driven by the battery 618. Note, also, that the audio input unit 609 includes a microphone into which audio is input. The audio output unit 610 includes a speaker from which audio is output.

The smart device 10 of the present embodiment may implement various processes described below using the hardware configuration of the terminal apparatus 600 as illustrated in FIG. 3, for example.

<<Electronic Device>>

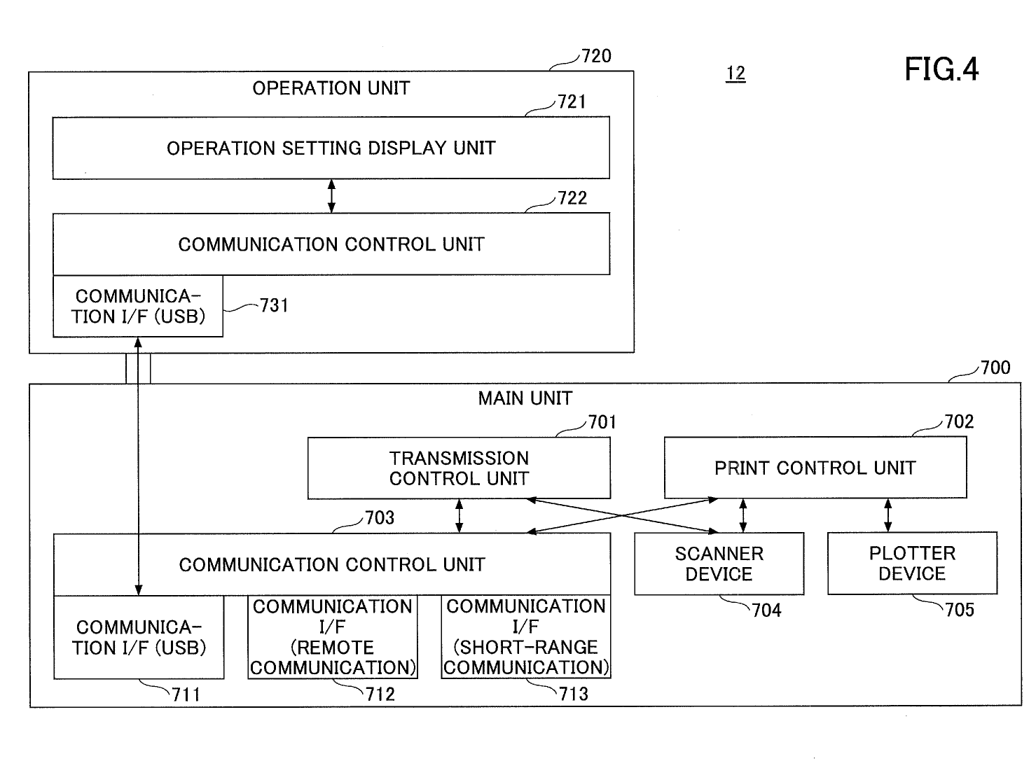

In the following, an exemplary hardware configuration of the MFP 12 as an example of an electronic device is described. FIG. 4 is a block diagram illustrating an exemplary hardware configuration of the MFP 12 according to the present embodiment.

In FIG. 4, the MFP 12 includes a main unit 700 and an operation unit 720. The main unit 700 includes a transmission control unit 701, a print control unit 702, a communication control unit 703, a scanner device 704, a plotter device 705, and communication I/Fs 711-713. The operation unit 720 includes an operation setting display unit 721, a communication control unit 722, and a communication I/F 731. The user may control the main unit 700 by operating the operation unit 720.

The communication I/F 711 of the main unit 700 and the communication I/F 731 of the operation unit 720 are interconnected by a USB (Universal Serial Bus) so that they may communicate with one another. The operation setting display unit 721 of the operation unit 720 includes a user I/F for accepting settings from the user and displaying information to the user. The communication control unit 722 controls data handled by the communication I/F 731, and transfers the data to the operation setting display unit 721 or the main unit 700. The communication I/F 731 is a USB communication device.

The transmission control unit 701 of the main unit 700 manages transmission jobs such as email and folder transmissions. The print control unit 702 controls devices such as the scanner device 704 and the plotter device 705 to manage print jobs.

The communication control unit 703 controls data handled by the communication I/Fs 711-713 and transmits the data to the transmission control unit 701, the print control unit 702, or the operation unit 720. Also, the communication control unit 703 transmits the data to the network N1.

The communication I/F 711 is a USB communication device. The communication I/F 712 is a communication device for long-distance communication. The communication I/F 712 may be implemented by a LAN, for example, and may be wireless or wired. The communication I/F 713 is a communication device for short-range communication. The communication I/F 713 may be implemented by Bluetooth (registered trademark), BLE (Bluetooth Low Energy), IrDA (Infrared Data Association), or the like.

### Software Configuration

<<Smart Device>>

The smart device 10 according to the present embodiment may be implemented by a functional configuration as illustrated in FIG. 5, for example. FIG. 5 is a block diagram illustrating an exemplary functional configuration of the smart device 10 according to an embodiment of the present invention.

The smart device 10 may execute a relevant program to implement a device detecting unit 21, an output job submitting unit 22, a PIN code information storage unit 23, a short-range communication receiving unit 24, a device ID verifying unit 25 and an output execution request unit 26.

The device detecting unit 21 detects an electronic device such as the MFP 12 that is capable of establishing short-range communication with the smart device 10 via the network N1. For example, if the electronic device has a fixed IP address, the device detecting unit 21 may have the IP address of the electronic device registered beforehand and detect the fixed IP address of the electronic device is capable of establishing short-range communication with the smart device 10. Also, in other examples, the device detecting unit 21 may automatically detect an electronic device within the network N1 using SNMP (Simple Network Management Protocol), Bonjour, or the like. Note that SNMP and Bonjour are examples of techniques for automatically detecting an electronic device within the network N1.

The output job submitting unit 22 submits an output job along with a PIN code to the electronic device such as the MFP 12 that has been detected by the device detecting unit 21, for example. The PIN code information storage unit 23 stores a device ID of the MFP 12 to which the output job has been submitted in association with the PIN code attached to the output job.

The short-range communication receiving unit 24 receives the device ID of the MFP 12 and a security code through short-range communication. Note that the communication range in short-range communication may be a distance of about several meters to several tens of meters, for example. The short-range communication receiving unit 24 may be able to receive the device ID of the MFP 12 and the security code from the MFP 12 if the smart device 10 is located within the communication range of short-range communication by the MFP 12. Note that the communication range of short-range communication by the MFP 12 may be appropriately adjusted. The device ID verifying unit 25 determines whether the device ID received by the short-range communication receiving unit 24 matches the device ID of the MFP 12 submitted along with the output job and stored in the PIN code information storage unit 23.

If the device ID received by the short-range communication receiving unit 24 and the device ID of the MFP 12 (electronic device that receives the output job submission) stored in the PIN code information storage unit 23 match, the output execution request unit 26 sends an output execution request to the MFP 12 through long-distance communication. At this time, the output execution request unit 26 sends the output execution request along with the security code received by the short-range communication receiving unit 24 and the PIN code stored in the PIN code information storage unit 23.

Note that the security code sent along with the output execution request indicates that the smart device 10 is within the communication range of short-range communication by the MFP 12. Also, the PIN code sent along with the output execution request identifies the output job to be executed in response to the output execution request.

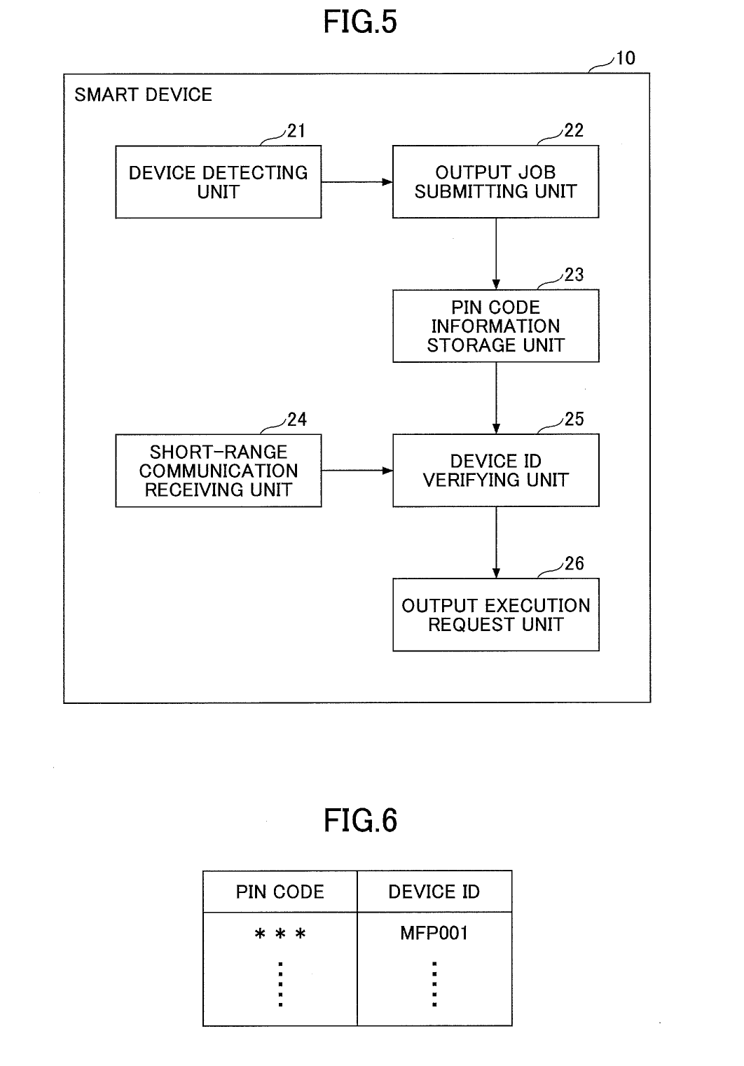

The PIN code information storage unit 23 may store information as illustrated in FIG. 6, for example. FIG. 6 is a table illustrating an exemplary configuration of information stored in the PIN code information storage unit 23. In FIG. 6, the PIN code information storage unit 23 stores the device ID of the MFP 12 to which the output job has been submitted in association with the PIN code that has been attached to the output job.

Using the information as illustrated in FIG. 6 that is stored in the PIN code information storage unit 23, the smart device 10 may be able to identify the PIN code that has been submitted to the electronic apparatus upon submitting the output job and send the identified PIN code along with the output execution request to the electronic device.

<<MFP>>

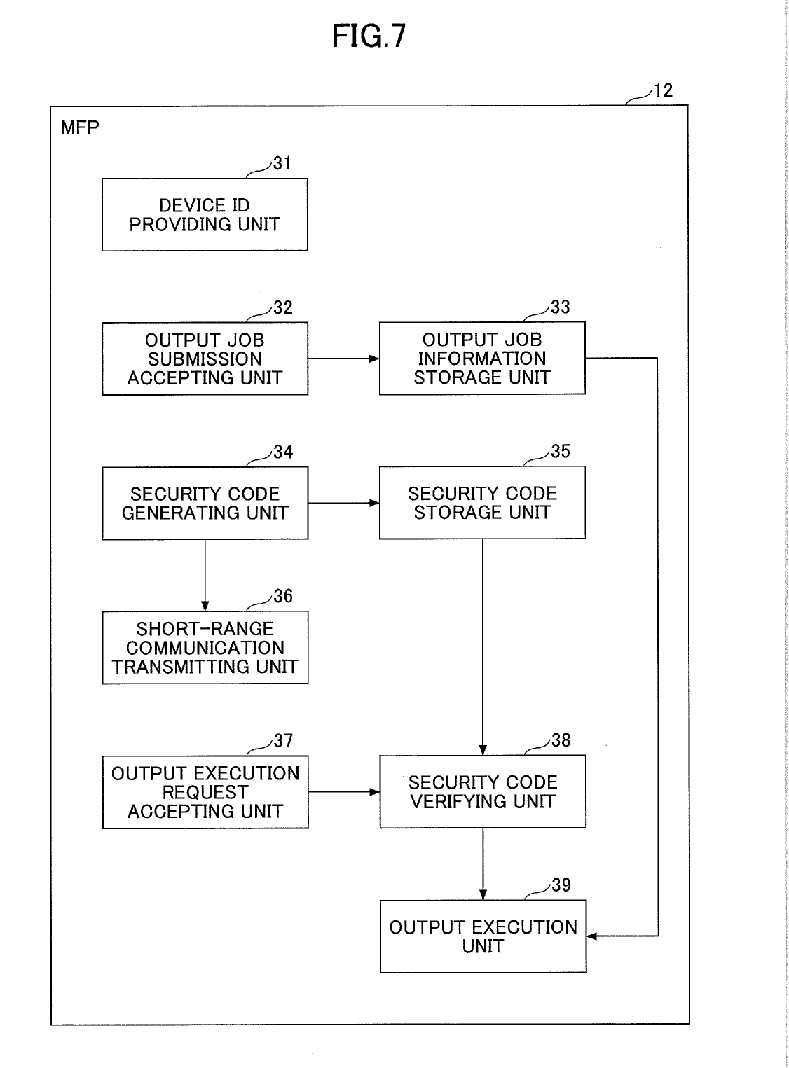

In the following, a functional configuration of the MFP 12 as one example of an electronic device is described. The MFP 12 of the present embodiment may be implemented by processing blocks as illustrated in FIG. 7, for example. FIG. 7 is a process block diagram illustrating one exemplary functional configuration of the MFP according to the present embodiment.

The MFP 12 executes a relevant program to implement a device ID providing unit 31, an output job submission receiving unit 32, an output job information storage unit 33, a security code generating unit 34, a security code storage unit 35, a short-range communication transmitting unit 36, an output execution request receiving unit 37, a security code verifying unit 38, and an output execution unit 39.

The device ID providing unit 31 provides its device ID (device ID of the MFP 12) to the smart device 10 that is capable of establishing long-distance communication with the MFP 12 via the network N1. The output job submission receiving unit 32 accepts the submission of the output job along with the PIN code from the smart device 10. The output job information storage unit 33 stores the output job from the smart device 10 accepted by the output job submission receiving unit 32 and the PIN code submitted along with the output job in association with each other.

The security code generating unit 34 generates a security code. The security code generating unit 34 generates the security code to be a random value that varies with time. Also, the security code storage unit 35 stores the security code that has been generated by the security code generating unit 34.

The short-range communication transmitting unit 36 transmits the security code and the device ID of the MFP 12 through short-range communication. The output execution request receiving unit 37 receives the output execution request along with the security code and the PIN code from the smart device 10 through long-distance communication.

The security code verifying unit 38 determines whether the security code received along with the output execution request matches a security code stored in the security code storage unit 35. If the security code that has been received along with the output execution request is stored in the security code storage unit 35, the output job execution unit 39 acquires from the output job information storage unit 33 the output job stored in association with the PIN code that was received along with the output execution request. Then, the output execution unit 39 executes the output job.

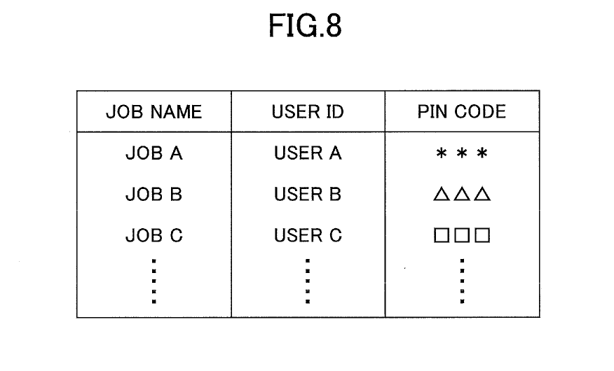

The output job information storage unit 33 may store information as illustrated in FIG. 8, for example. FIG. 8 is a table illustrating an exemplary configuration of information stored in the output job information storage unit 33. As illustrated in FIG. 8, the output job information storage unit 33 may store the job name of the output job accepted from the smart devices 10, the user ID of the user, and the PIN code accepted along with the output job in association with each other. By storing the information as illustrated in FIG. 8, even when multiple output jobs have been submitted to the MFP 12, the MFP 12 may be able to identify an output job to be executed based on the PIN code transmitted along with the output execution request and execute the corresponding output job.

### Processes

In the following, processes of the information processing system 1 according to an embodiment of the present invention are described in detail.

<<Print Process>>

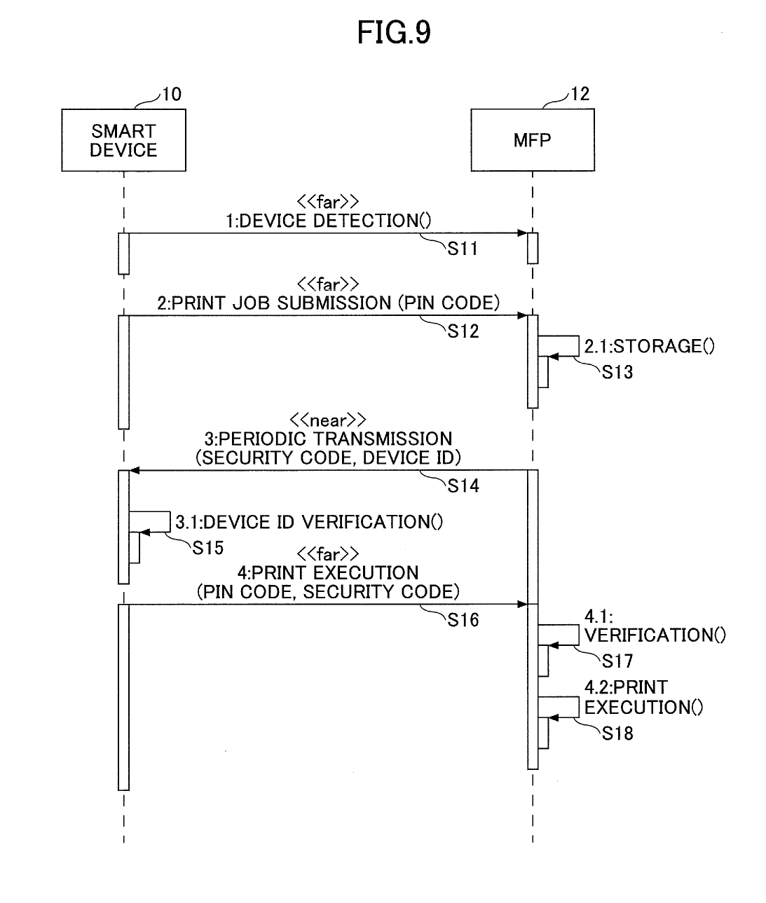

The information processing system 1 according to the present embodiment may perform a print process as illustrated in FIG. 9, for example. FIG. 9 is a sequence chart illustrating an exemplary sequence of process steps of a print process according to an embodiment of the present invention. Note that in FIG. 9, <<far>> represents long-distance communication, and <<near>> represents short-range communication.

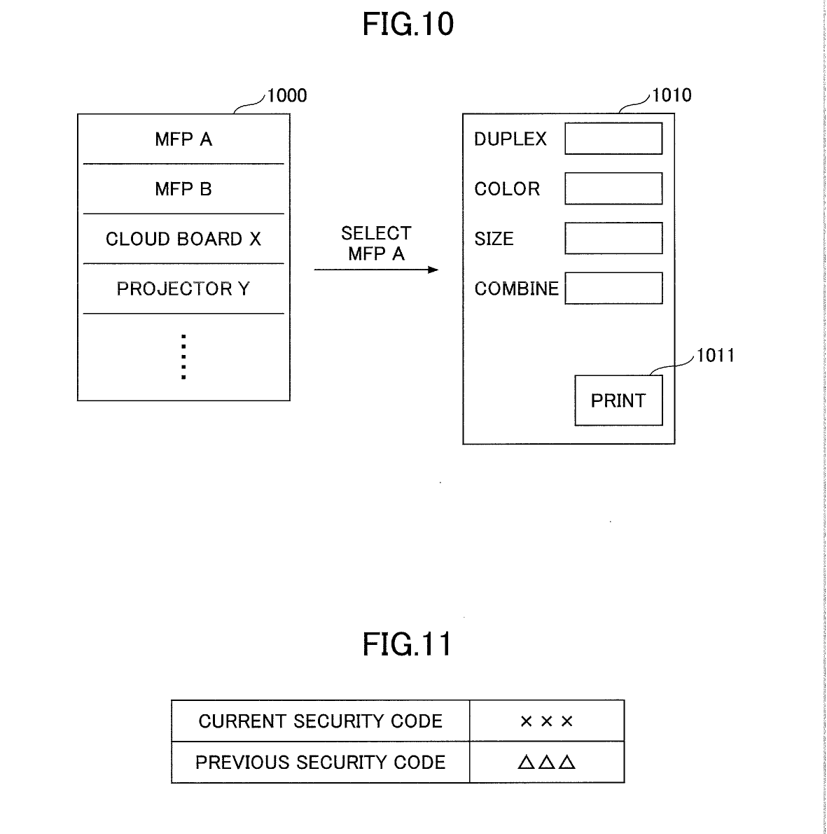

To control an MFP 12 from the smart device 10, the MFP 12 to be used must be specified. Accordingly, in step S11, the device detecting unit 21 of the smart device 10 detects one or more electronic devices such as the MFP 12 that are capable of establishing long-distance communication with the smart device 10 via the network N1. The output job submitting unit 22 may then select an MFP 12 to be used by the user from a list of electronic devices detected by the device detecting unit 21 as illustrated in FIG. 10, for example.

FIG. 10 illustrates an example of a selection screen 1000 for selecting an electronic device that is to be the submission destination of a print job (output job). The selection screen 1000 of FIG. 10 displays a list of electronic devices detected by the device detecting unit 21 to enable selection of an electronic device to be used. When the MFP 12 is selected as the electronic device to be used, for example, the output job submitting unit 22 may switch the selection screen 1000 to a setting screen 1010 to accept setting information required for executing the print job (output job). When a print button 1011 of the setting screen is pressed by the user, the output job submitting unit 22 may proceed to step S12.

In step S12, the output job submitting unit 22 submits the output job along with a PIN code to the MFP 12 that has been selected by the user. Note that a unique value that is randomly generated for each output job at the smart device 10 may be used as the PIN code. Also, the user need not be aware of the PIN code.

In step S13, the output job information storage unit 33 of the MFP 12 stores the output job in association with the PIN code accepted by the output job input receiving unit 32 from the smart device 10.

In step S14, the short-range communication transmitting unit 36 of the MFP 12 periodically transmits its device ID (device ID of the MFP 12) and a security code to the smart device 10 through short-range communication at predetermine time intervals, for example. The short-range communication receiving unit 24 of the smart device 10 that is within the communication range of short-range communication by the MFP 12 receives the device ID of the MFP 12 and the security code from the MFP 12 through short-range communication.

Note that a random value that varies with time is generated as the security code. Thus, the security code that has been captured previously may not be valid. In step S15, the device ID verifying unit 25 determines whether the device ID received by the short-range communication receiving unit 24 matches the device ID stored in the PIN code information storage unit 23 identifying the MFP 12 to which the output job was submitted.

If the device ID received by the short-range communication receiving unit 24 matches the device ID stored in the PIN code information storage unit 23 identifying the MFP 12 to which the output job was submitted, the output execution request unit 26 sends an output execution request (print execution request) to the MFP 12 through long-distance communication in step S16. Note that the output execution request unit 26 sends the output execution request along with the security code received by the short-range communication receiving unit 24 and the PIN code stored in the PIN code information storage unit 23.

In step S17, the output execution request receiving unit 37 of the MFP 12 accepts the output execution request from the smart device 10 and the security code and the PIN code transmitted along with the output execution request through long-distance communication.

The security code verifying unit 38 verifies whether the security code received along with the output execution request is stored in the security code storage unit 35. If the security code that has been received along with the output execution request is stored in the security code storage unit 35, the output execution unit 39 proceeds to step S18. In step S18, the output execution unit 39 acquires from the output job information storage unit 33 the output job stored in association with the PIN code received along with the output execution request, and executes the acquired output job.

Note that because the security code is a random value that varies with time, the security code may be suddenly switched to a different value with the elapse of time. For example, the security code may be switched between the time the smart device 10 receives the security code from the MFP 12 in step S14 and the time the smart device 10 sends the output execution request to the MFP 12 in step S16.

In such case, if the security code storage unit 35 only stores the current security code, verification of the security code by the security code verifying unit 38 in step S17 would fail. Accordingly, in a preferred embodiment, the security code storage unit 35 stores the current security code (newest version) and a previous security code (previous version) as illustrated in FIG. 11. FIG. 11 illustrates an exemplary configuration of security code information stored in the security code storage unit 35.

Note that the security code information stored in the security code storage unit 35 is merely one example, and in other examples the security code storage unit 35 may be configured to store the current security code and two or more previous security codes.

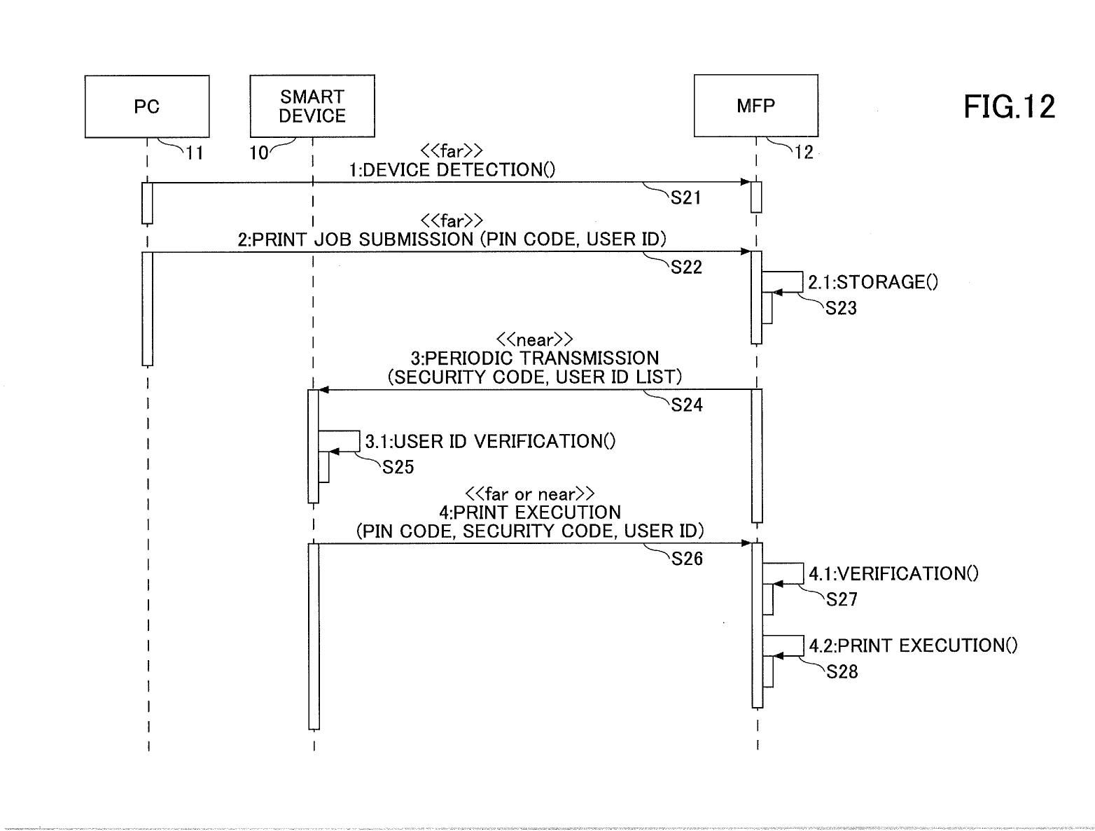

In the process illustrated in FIG. 9, the print job (output job) is submitted from the smart device 10. In the information processing system 1 according to the present embodiment, a print job may also be submitted from the PC 11 and executed by the MFP 12 as illustrated in FIG. 12, for example.

FIG. 12 is a sequence chart illustrating another exemplary sequence of process steps of a print process according to an embodiment of the present invention. Note that the print process of FIG. 12 includes some process steps that are substantially identical to the process steps of FIG. 9, and as such, descriptions thereof may be omitted as appropriate. Note that in the print process of FIG. 12, it is assumed that the user ID and the PIN code used by the PC 11 and the smart device 10 are in synch with each other. Also, it is assumed that the PIN code is a fixed value.

To control an MFP 12 from the PC 11, the MFP 12 to be used must be specified. Accordingly, in step S21, the PC 11 detects electronic devices such as the MFP 12 that are capable of establishing long-distance communication with the PC 11 via the network N1. The PC 11 prompts the user to select the MFP 12 to be used from a list of the detected electronic devices.

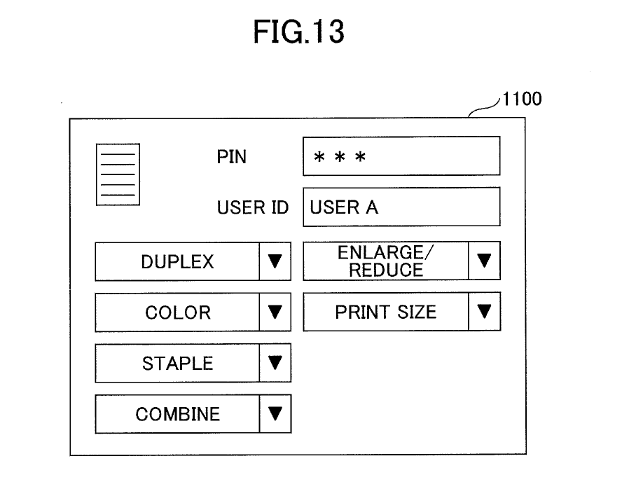

Also, the PC 11 may display a setting screen 1100 as illustrated in FIG. 13, for example, to accept a PIN code, a user ID, and setting information required for executing a print job (output job) from the user. FIG. 13 illustrates an example of a setting screen for prompting the user to input the PIN code and the user ID.

In step S22, the PC 11 submits the print job (output job) along with the PIN code and the user ID input by the user to the MFP 12 selected by the user. In step S23, the output job information storage unit 33 of the MFP 12 stores the print job (output job) accepted from the PC 11 by the output job submission receiving unit 32 in association with the PIN code and the user ID.

In step S24, the short-range communication transmitting unit 36 of the MFP 12 periodically transmits a security code and a list of user IDs that are stored in the output job information storage unit 33 through short-range communication at predetermined time intervals, for example.

The short-range communication receiving unit 24 of the smart device 10 that is located within the communication range of short-range communication by the MFP 12 receives the user ID list and the security code from the MFP 12 via short-range communication. In step S25, the smart device 10 determines whether the user ID of the user operating the smart device 10 is included in the user ID list received by the short-range communication receiving unit 24.

Note that in the process of FIG. 12, the device ID verifying unit 25 of the smart device 10 as illustrated in FIG. 5 is replaced by a user ID verifying unit that determines whether the user ID of the user operating the smart device 10 is included in the user ID list received from the MFP 12.

If the user ID of the user operating the smart device 10 is included in the user ID list received from the MFP 12, the output execution request unit 26 proceeds to step S26 and sends an output execution request (print execution request) to the MFP 12 through long-distance communication. The output execution request unit 26 sends the output execution request along with the PIN code stored in the PIN code information storage unit 23, the security code received by the short-range communication receiving unit 24, and the user ID of the user operating the smart device 10.

Note that the PIN code, the security code, and the user ID transmitted to the MFP 12 along with the output execution request are information used by the MFP 12 for authentication and identification of the output job to be executed. Note that step S26 may be executed through short-range communication or long-distance communication. Generally, in short-range communication, the data transmission rate is relatively low such that it is not suitable for transmitting a large amount of data such as print data. However, because the amount of data transmitted in step S26 is relatively small, either short-range communication or long-distance communication may be used in this step.

In step S27, the output execution request receiving unit 37 of the MFP 12 accepts the output execution request accompanied by the security code, the PIN code, and the user ID from the smart device 10.

The security code verifying unit 38 determines whether the security code accepted along with the output execution request is stored in the security code storage unit 35. If the security code accepted along with the output execution request is stored in the security code storage unit 35, the output execution unit 39 proceeds to step S28. In step S28, the output execution unit 39 obtains the output job that is stored in association with the PIN code and the user ID that has been accepted along with the output execution request from the output job information storage unit 33, and executes the output job.

Note that in the processes illustrated in FIGS. 9 and 12, the MFP 12 is controlled from the smart device 10. In the information processing system 1 according to the present embodiment, for example, the IWB 13 may also be controlled from the smart device 10.

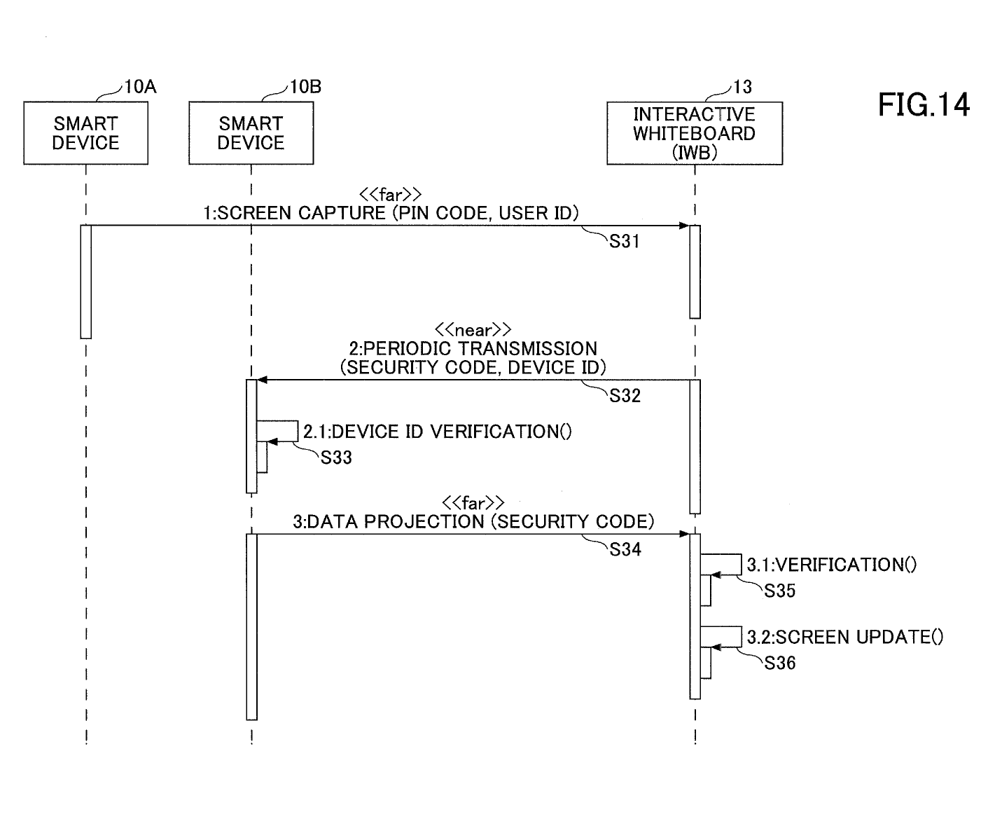

FIG. 14 is a sequence chart illustrating an exemplary sequence of process steps of a display process implemented by the IWB 13. Note that in FIG. 14, an exemplary case where the IWB 13 is controlled from the smart device 10 to implement read control and write control is described. It is assumed in the present example that any smart device 10 is able to use a read control function of the IWB 13. On the other hand, it is assumed that only a smart device 10 that has received a security code from the IWB 13 is able to use a write control function of the IWB 13.

Further, in FIG. 14, it is assumed that the smart device 10A is in a location where it is unable to receive a security code from the IWB 13, and the smart device 10B is in a location where it is able to receive a security code from the IWB 13. Because the smart device 10A cannot receive a security code from the IWB 13, the smart device 10 can perform read control operations such as screen sharing or screen capturing operations with respect to the IWB 13 as illustrated in step S31.

On the other hand, the short-range communication receiving unit 24 of the smart device 10B can receive a security code and a device ID of the IWB 13 from the IWB 13 through short-range communication in step S32.

In step S33, the device ID verifying unit 25 of the smart device 10B verifies the device ID of the IWB 13 received by the short-range communication receiving unit 24. In step 34, the output execution request unit 26 sends a data projection request (output execution request) to the IWB 13 through long-distance communication. The output execution request unit 26 sends the data projection request along with the security code received by the short-range communication receiving unit 24.

In step S35, the IWB 13 accepts the data projection request along with the security code from the smart device 10B through long-distance communication. The IWB 13 determines whether the security code accepted along with the data projection request corresponds to a security code that has been generated at the IWB 13.

If the security code accepted along with the data projection request corresponds to a security code that has been generated at the IWB 13, the IWB 13 proceeds to step S36 and executes data projection according to the data projection request accepted from the smart device 10B.

As can be appreciated, in the example of FIG. 14, the IWB 13 allows execution of different control operations from the smart device 10 depending on its distance from the IWB 13. For example, FIG. 14 may be applied to a classroom setting where the smart device 10A is operated by a student, and the smart device 10B is operated by a teacher such that only the teacher is able to execute data projection. Note that although the IWB 13 transmits a security code and the device ID of the IWB 13 to the smart device 10B through short-range communication in step S32 of FIG. 14, the device ID does not necessarily have to be transmitted in this step. If the device ID is not transmitted, the process of step S33 may be omitted.

According to an aspect of the present embodiment, a smart device 10 that has acquired a security code from an electronic device through short-range communication is able to control the electronic device. In this way, a user may be prevented from erroneously controlling an electronic device that the user has not intended to control.

### Second Embodiment

In the first embodiment described above, an electronic device is configured to transmit a security code. In a second embodiment of the present invention, a security beacon 18 is configured to transmit a security code instead of the electronic device.

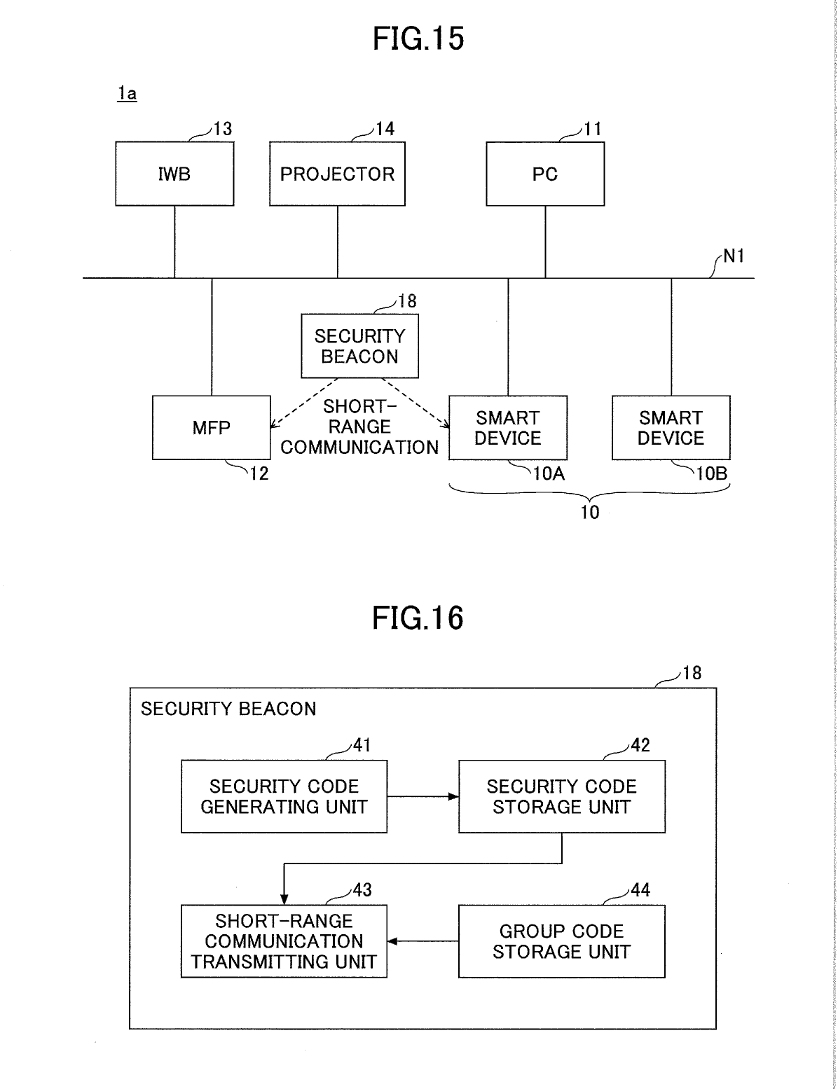

FIG. 15 is a block diagram illustrating an exemplary configuration of an information processing system 1a according to the second embodiment. The information processing system 1a of FIG. 15 includes the security beacon 18 in addition to the elements of the information processing system 1 illustrated in FIG. 1. The security beacon 18 is a short-range communication device for transmitting a security code. In the present embodiment, electronic devices such as the PC 11, the MFP 12, the IWB 13, and the projector 14 of the information processing system 1a are configured to receive a security code instead of transmitting a security code. The security beacon 18 may be attached to a microphone or a pointer device of the projector 14, for example.

The security beacon 18 of the present embodiment may be implemented by functional elements as illustrated in FIG. 16, for example. FIG. 16 is a block diagram illustrating an exemplary functional configuration of the security beacon 18 according to the present embodiment.

The security beacon 18 executes a relevant program to implement a security code generating unit 41, a security code storage unit 42, a short-range communication transmitting unit 43, and a group code storage unit 44.

The security code generating unit 41 generates a security code. The security code generating unit 41 generates a random value that varies with time as the security code. Also, the security code storage unit 42 stores the security code generated by the security code generating unit 34. The group code storage unit 44 stores a group code.

The group code is a unique fixed value that represents a group of electronic devices that are associated with the security beacon 18. Also, the short-range communication transmitting unit 43 transmits the security code and the group code through short-range communication.

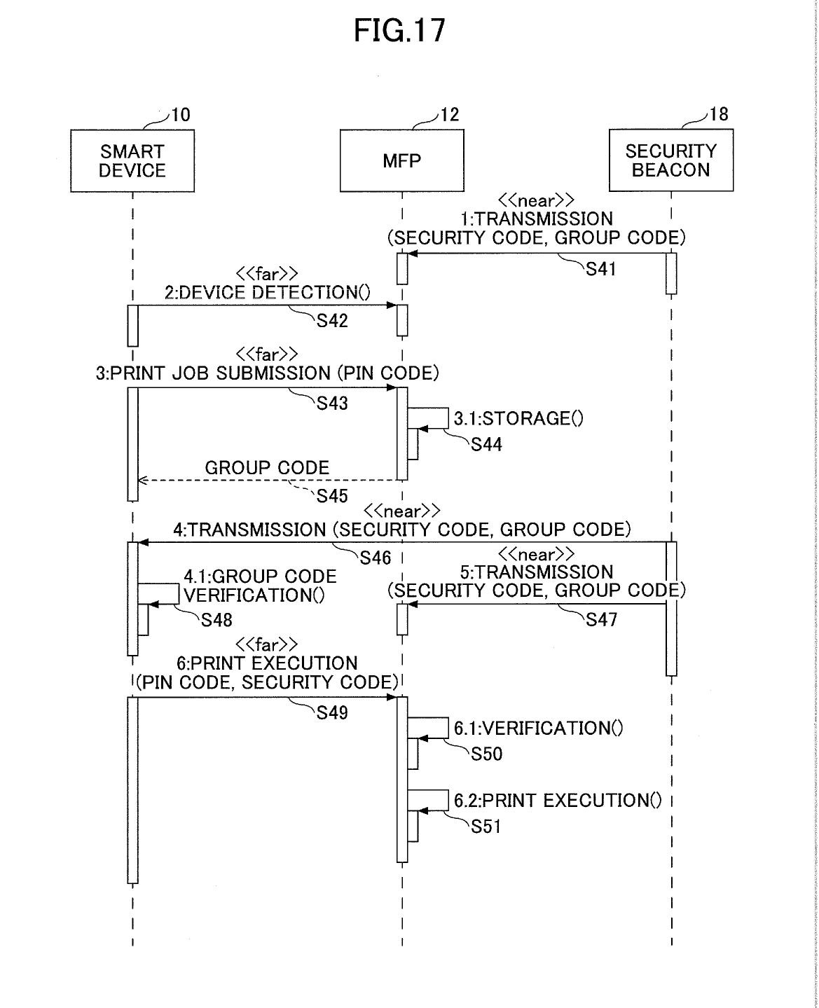

The information processing system 1a according to the second embodiment may perform a print process as illustrated in FIG. 17, for example. FIG. 17 is a sequence chart illustrating an exemplary sequence of process steps of a print process. In step S41, the short-range communication transmitting unit 43 of the security beacon 18 periodically transmits the security code and the group code through short-range communication at predetermined intervals, for example.

The MFP 12 that is located within the communication range of short-range communication by the security beacon 18 receives the security code and the group code from the security beacon 18 through short-range communication. Note that in the example of FIG. 17, the security code generating unit 34 of the MFP 12 illustrated in the example of FIG. 17 is replaced by a short-range communication receiving unit for receiving the security code and the group code from the security beacon 18 through short-range communication.

In step S42, the device detecting unit 21 of the smart device 10 detects an electronic device such as the MFP 12 that is capable of establishing long-distance communication with the smart device 10 via the network Ni. The output job submitting unit 22 may then select the MFP 12 to be used by the user from a list of electronic devices detected by the device detecting unit 21.

In step S43, the output job submitting unit 22 submits a print job (output job) along with a PIN code to the MFP 12 selected by the user. In step S44, the output job information storage unit 33 of the MFP 12 stores the output job received by the output job submission receiving unit 32 from the smart device 10 in association with the PIN code. Also, in step S45, the MFP 12 sends the group code of the group to which it belongs to the smart device 10.

In step S46, the short-range communication receiving unit 24 of the smart device 10 that is located within the communication range of short-range communication by the security beacon 18 receives the security code and the group code from the security beacon 18 through short-range communication. Also, in step S47, the MFP 12 that is located within the communication range of short-range communication by the security beacon 18 receives the security code and the group code from the security beacon 18 through short-range communication.

In step S48, the smart device 10 determines whether the group code received by the short-range communication receiving unit 24 matches the group code received from the MFP 12 in step S45.

If the group code received by the short-range communication receiving unit 24 matches the group code received from the MFP 12 in step S45, the output execution request unit 26 proceeds to step S49 and sends an output execution request (print execution request) to the MFP 12. The output execution request unit 26 sends the output execution request along with the security code received by the short-range communication receiving unit 24 and the PIN code stored in the PIN code information storage unit 23.

In step S50, the output execution request receiving unit 37 of the MFP 12 accepts the output execution request, the security code, and the PIN code from the smart device 10 through long-distance communication.

The security code verifying unit 38 determines whether the security code accepted along with the output execution request is stored in the security code storage unit 35. If the security code accepted along with the output execution request is stored in the security code storage unit 35, the output execution unit 39 proceeds to step S51. In step S51, the output execution unit 39 obtains the output job that is stored in association with the PIN code accepted along with the output execution request from the output job information storage unit 33 and executes the output job.

Note that although the security codes transmitted by the security beacon 18 in steps 41, S46, and S47 of FIG. 17 are accepted as is, security may be heightened by using electronic signatures or by pre-registering group information of each electronic device in each electronic device, for example.

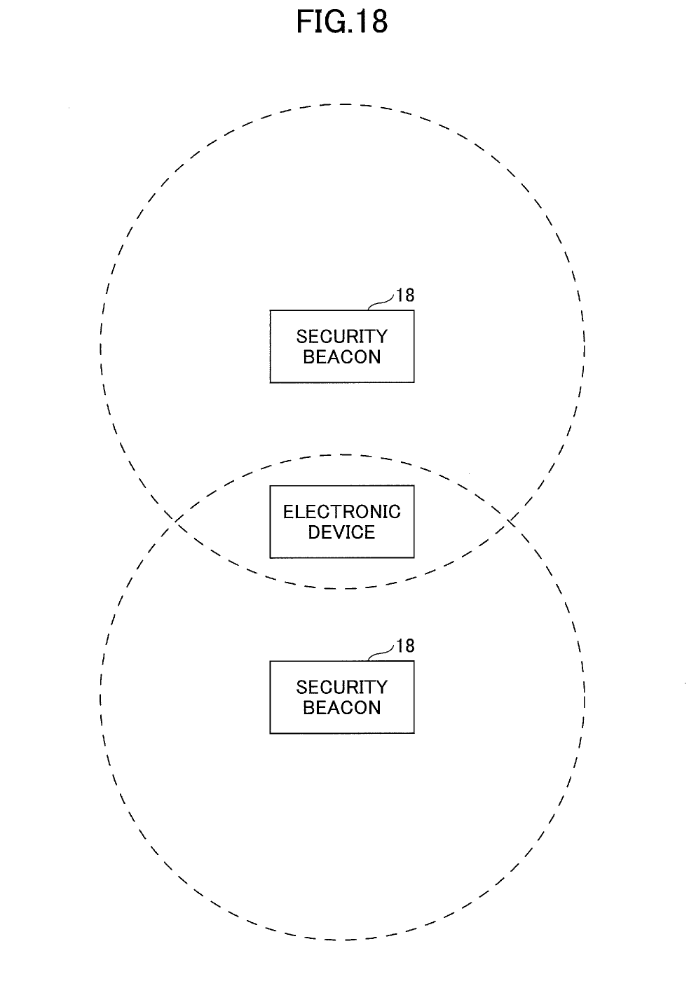

In a case where an electronic device is configured to receive security codes from a plurality of security beacons 18 as illustrated in FIG. 18, for example, by pre-registering group information of each electronic device in each electronic device, the groups to which the electronic device belongs can be clearly set out.

Also, in another embodiment, one of the plurality of electronic devices included in the information processing system 1a of FIG. 15 may be configured perform the functions of the security beacon 18. Also, in another embodiment, pairing of an electronic device and a security beacon 18 may be implemented in advance, and stand-alone calculation of the current security code may be performed based on the pairing information and the current time. In the case where the electronic device is capable of performing stand-alone calculation of the security code, the electronic device would not have to receive the security code from the security beacon 18.

In the case of implementing the stand-alone scheme as described above, the security code may be calculated as follows. In the stand-alone scheme, the security code may be determined by a certain formula. As a simple method, a security code generation formula using a pseudo-random algorithm, a unique ID of the security beacon 18 and the current time as parameters may be used, for example.

When a simple pseudo random number algorithm is used, a random number generated by the initial value may be uniquely determined. Note that in the present example, it is assumed that a pseudo-random algorithm that is determined between the security beacon 18 and the electronic device is provided.

In addition, a pseudo random number may be generated based on the sum of a hash value of the unique ID of the security beacon 18 and the current time (in seconds counting from 1970) as an initial value, and the generated pseudo random number may be provided as a security code.

Also, in the case of implementing the stand-alone scheme, pairing may be implemented as follows, for example. Because the electronic device is unaware of the unique ID of the security beacon 18, when paired, the unique ID of the security beacon 18 may be registered in the electronic device. In the present example, it is assumed that pairing is implemented by a user input.

Also, in the case of implementing the stand-alone scheme, time synchronization may be implemented as follows. Because the current time is included in the security code generation formula, the time of the electronic device and the time of the security beacon 18 have to be synchronized. Thus, it is assumed in the present example that the times of the electronic device and the security beacon 18 are in synch before pairing the electronic device and the security beacon 18.

Also, in the case of implementing the stand-alone scheme, time correction may be performed as follows, for example. Even when the times of the electronic device and the security beacon 18 are synchronized at the time of pairing, deviations may be created between the times of the electronic device and the security beacon 18 with the elapse of time. In order to correct such deviations, time information may be included in the information transmitted by the security beacon 18, and the time information may be transmitted along with the security code to the electronic device via the smart device 10 when the smart device 10 submits an output execution request to the electronic device, for example. If the received time information is reliable, the electronic device may update the current time based thereon. In this way, the times of the security beacon 18 and the electronic device may be periodically synchronized and corrected.

Furthermore, in the case of implementing the stand-alone scheme, measures may be implemented to tolerate a certain amount of time deviations. Even if time correction is performed, time deviations may still be created when the electronic device is not used for a relatively long period of time, for example.

In this respect, for example, the calculation using the current time may be performed in increments of 5 minutes at both the electronic device and the security beacon 18. In a verification process performed by the electronic device, security codes may be calculated using the exact time and the exact time ±5 minutes, and any of the security codes may be regarded as valid values in the verification process. In this way, a certain amount of time deviations may be tolerated between the electronic device and the security beacon 18.

For example, if the current time at the security beacon 18 is “2014/07/31/15:05:07”, the security code may be calculated using the time “2014/07/31/15:00:05”. Also, if the current time at the electronic device is “2014/07/31/15:12:21”, the times used for calculating the security codes to be used in the verification process may be “2014/07/31/15:5:00”, “2014/07/31/15:10:00”, and “2014/07/31/15:15:00”.

As can be appreciated from the above, in the information processing systems 1 and 1a according to embodiments of the present invention, a user carrying a smart device 10 may come close to or in the vicinity of an electronic device that the user wishes to control, and the smart device 10 may in turn acquire a security code that is required for controlling the electronic device. In such a system, the smart device 10 would not receive a security code from an electronic device that is not in the vicinity of the smart device 10, and in this way, the user may be prevented from erroneously controlling an electronic device the user does not wish to control (electronic device that is not in the vicinity of the smart device 10).

As described above, in the information processing systems 1 and 1a according to embodiments of the present invention, a user can be prevented from erroneously controlling an electronic device such as an MFP 12 that the user does not wish to control.

Although the present invention has been described above with reference to certain illustrative embodiments, the present invention is not limited to these embodiments, and numerous variations and modifications may be made without departing from the scope of the present invention. Note that the smart device 10 of the above described embodiments is an example of a terminal apparatus according to the present invention. The MFP 12, the IWB 13, and the projector 14 are examples an electronic device according to the present invention.

Also, the wireless LAN communication unit 613 and the communication interface 712 for long-distance communication are examples of a first communication interface, and the short-range wireless communication unit 615 and the communication interface 713 for short-range communication are examples of a second communication interface. The security code is an example of certification information. The PIN code is an example of identification information. The short-range communication transmitting unit 36 is an example of a certification information transmitting unit, and the security beacon 18 is an example of a certification information transmitting apparatus.

The present application is based on and claims the benefit of priority of Japanese Patent Application No. 2015-027290 filed on Feb. 16, 2015, the entire contents of which are hereby incorporated by reference.

What is claimed is:

1. An information processing system comprising:
at least one terminal apparatus that is operated by a user; and
at least one electronic device that is controlled from the terminal apparatus;
wherein the terminal apparatus and the electronic device are configured to establish communication using a first communication interface having a first communication range and a second communication interface having a second communication range that is shorter than the first communication range;
wherein the electronic device includes
a certification information transmitting unit configured to transmit certification information using the second communication interface;
a verifying unit configured to verify whether the certification information is attached to a request from the terminal apparatus that is accepted using the first communication interface or the second communication interface; and
an execution unit configured to execute a process according to the request accepted from the terminal apparatus if the certification information is attached to the request; and
wherein the terminal apparatus includes
a certification information receiving unit configured to receive the certification information that has been transmitted by the electronic device using the second communication interface; and
a request unit configured to attach the certification information to the request and transmit the request along with the certification information to the electronic device using the first communication interface or the second communication interface.

2. The information processing system as claimed in claim 1, wherein
the electronic device further includes
a certification information generating unit configured to generate the certification information that varies with time; and
a certification information storage unit configured to store the certification information that has been transmitted by the certification information transmitting unit at predetermined time intervals; and
the verifying unit verifies whether the certification information that is stored in the certification information storage unit is attached to the request accepted from the terminal apparatus.

3. The information processing system as claimed in claim 2, wherein
the certification information storage unit stores a plurality of versions of the certification information including a newest version and at least one previous version of the certification information that has been transmitted at predetermined time intervals by the certification information transmitting unit.

4. The information processing system as claimed in claim 1, wherein
the electronic device further includes an accepting unit configured to accept from the terminal apparatus a submission of information required by the execution unit for executing the process along with identification information; and
the execution unit identifies the information required by the execution unit for executing the process based on the identification information that is attached to the request accepted from the terminal apparatus, and executes the process according to the request accepted from the terminal apparatus.

5. The information processing system as claimed in claim 1, further comprising:
a certification information transmitting apparatus configured to transmit the certification information instead of the electronic device using the second communication interface;
wherein the electronic device and the terminal apparatus receive the certification information from the certification information transmitting apparatus using the second communication interface.

6. The information processing system as claimed in claim 1, wherein
when the certification information is not attached to the request accepted from the terminal apparatus, the execution unit is configured to allow execution of a different process that is different from the process to be executed when the certificate information is attached to the request.

7. An information processing system comprising:
an application that is implemented by a processor of at least one terminal apparatus that is operated by a user; and
at least one electronic device that is controlled from the application that is installed in the terminal apparatus;
wherein the application and the electronic device are configured to establish communication using a first communication interface having a first communication range and a second communication interface having a second communication range that is shorter than the first communication range;
wherein the electronic device includes
a certification information transmitting unit configured to transmit certification information using the second communication interface;
a verifying unit configured to verify whether the certification information is attached to a request from the application that is accepted using the first communication interface or the second communication interface; and
an execution unit configured to execute a process according to the request accepted from the application if the certification information is attached to the request; and
wherein the application includes
a certification information receiving unit configured to receive the certification information that has been transmitted by the electronic device using the second communication interface; and
a request unit configured to attach the certification information to the request and transmit the request along with the certification information to the electronic device using the first communication interface or the second communication interface.

8. The information processing system as claimed in claim 7, further comprising:
a certification information transmitting apparatus configured to transmit the certification information instead of the electronic device using the second communication interface;
wherein the electronic device and the application receive the certification information from the certification information transmitting apparatus using the second communication interface.

9. The information processing system as claimed in claim 7, wherein
the electronic device further includes
a certification information generating unit configured to generate the certification information that varies with time; and
a certification information storage unit configured to store the certification information that has been transmitted by the certification information transmitting unit at predetermined time intervals; and
the verifying unit verifies whether the certification information that is stored in the certification information storage unit is attached to the request accepted from the application.

10. The information processing system as claimed in claim 9, wherein
the certification information storage unit stores a plurality of versions of the certification information including a newest version and at least one previous version of the certification information that has been transmitted at predetermined time intervals by the certification information transmitting unit.

11. The information processing system as claimed in claim 7, wherein
the electronic device further includes an accepting unit configured to accept from the application a submission of information required by the execution unit for executing the process along with identification information; and
the execution unit identifies the information required by the execution unit for executing the process based on the identification information that is attached to the request accepted from the application, and executes the process according to the request accepted from the application.

12. A device control method that is implemented by an information processing system including at least one terminal apparatus that is operated by a user and at least one electronic device that is controlled from the terminal apparatus, wherein the terminal apparatus and the electronic device are configured to establish communication using a first communication interface having a first communication range and a second communication interface having a second communication range that is shorter than the first communication range, the device control method comprising:
a certification information transmitting step of transmitting certification information using the second communication interface;
a certification information receiving step in which the terminal apparatus receives the certification information using the second communication interface;
a requesting step in which the terminal apparatus transmits a request for execution of a process to the electronic device using the first communication interface or the second communication interface, and attaches the certification information along with the request that is transmitted;
a verifying step in which the electronic device verifies whether the certification information is attached to the request that has been accepted from the terminal apparatus using the first communication interface or the second communication interface; and
an executing step in which the electronic device executes the process according to the request accepted from the terminal apparatus if the certification information is attached to the request.

13. The device control method as claimed in claim 12, further comprising:
a certification information generating step in which the electronic device generates the certification information that varies with time; and
a certification information storing step in which the electronic device stores the certification information that has been transmitted by the certification information transmitting unit at predetermined time intervals;
wherein the verifying step includes verifying whether the certification information that has been stored in the certification information storing step is attached to the request accepted from the terminal apparatus.

14. The device control method as claimed in claim 13, wherein
the certification information storing step includes storing a plurality of versions of the certification information including a newest version and at least one previous version of the certification information that has been transmitted at predetermined time intervals in the certification information transmitting step.

15. The device control method as claimed in claim 12, further comprising:
an accepting step in which the electronic device accepts from the terminal apparatus a submission of information required by the electronic device for executing the process along with identification information;
wherein the executing step includes identifying the information required by the electronic device for executing the process based on the identification information that is attached to the request accepted from the terminal apparatus, and executing the process according to the request accepted from the terminal apparatus.

16. The device control method as claimed in claim 12, wherein
the information processing system further includes a certification information transmitting apparatus configured to transmit the certification information instead of the electronic device using the second communication interface; and
the electronic device and the terminal apparatus receive the certification information from the certification information transmitting apparatus using the second communication interface.

17. The device control method as claimed in claim 12, wherein
the executing step includes allowing execution of a different process that is different from the process to be executed when the certificate information is attached to the request if the certification information is not attached to the request accepted from the terminal apparatus.
